(19) United States
(12) Patent Application Publication
(10) Pub. No.: US 2007/0177867 A1
(43) Pub. Date: Aug. 2, 2007

(54) Camera

(75) Inventors: Kazunori Yuge, Tokyo (JP); Tetsumi Ichikawa, Tokyo (JP); Naoki Matsumoto, Tokyo (JP); Shinya Suzuki, Toyama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Imaging Corp., Tokyo (JP)

(21) Appl. No.: 11/657,310

(22) Filed: Jan. 24, 2007

(30) Foreign Application Priority Data
Jan. 24, 2006 (JP) 2006-015613

(51) Int. Cl. G03B 17/00

(52) U.S. Cl. 396/448; 396/79

(57) ABSTRACT

A camera is disclosed which comprises: a lens frame in which an optical system including a reflecting optical member is housed; a lens frame mounting part arranged on one side of the lens frame; a fixing member in which the lens frame is mounted through the lens frame mounting part in a direct or indirect manner; and one or more drive sources for driving movable portions in the camera. In this camera, at least one of the drive sources is arranged on the side of the lens frame mounting part with respect to an optical axis plane formed by optical axes before and after reflected by the reflecting optical member.

### CROSS-REFERENCE TO RELATED APPLICATION

This application is based upon and claims the benefit of priority from prior Japanese Patent Application No. 2006-015613, filed on Jan. 24, 2006, the entire contents of which are incorporated herein by reference.

### BACKGROUND OF THE INVENTION

1. Field of the Invention

The present invention relates to the arrangement and structure of a camera incorporating a lens frame therein.

2. Description of the Related Art

There has been a recent demand for smaller devices with shooting capability such as a camera. For example, a camera disclosed in Japanese Patent Application Laid-Open No. 2005-257784 employs a reflecting optical system for bending the optical axis of an incident light flux as a photographing optical system in a lens frame to make the device thinner. Then, in order to prevent adverse effects of the external loads placed on the lens frame, lens frame holding means is employed to hold the lens frame between two surfaces substantially parallel with each other.

Further, Japanese Patent Application Laid-Open No. 2002-341401 discloses a barrier device for a lens frame, which integrates a barrier opening/closing mechanism with the lens frame having a reflecting member for reflecting and bending an incident light flux.

### BRIEF SUMMARY OF THE INVENTION

The camera of the present invention includes a lens frame in which an optical system including a reflecting optical member is housed, a lens frame mounting part arranged on one side of the lens frame, a fixing member in which the lens frame is mounted through the lens frame mounting part in a direct or indirect manner, and one or more drive sources for driving movable portions of the camera. In the camera of the present invention, at least one of the drive sources is arranged on the side of the lens frame mounting part with respect to an optical axis plane formed by optical axes before and after reflected by the reflecting optical member.

An exemplary structure of the camera of the present invention is as follows: A camera comprises a lens frame having a reflecting optical member for reflecting light from a subject incoming along a first optical axis toward a second optical axis intersecting the first optical axis, a fixing member mounting the lens frame therein, a lens frame mounting part arranged on one side of the lens frame with respect to an optical axis plane defined by the first optical axis and the second optical axis, and a plurality of drive sources arranged in the lens frame to drive movable portions in the lens frame, wherein at least one of the plurality of drive sources is arranged on the side of the lens frame mounting part with respect to the optical axis plane.

Another exemplary structure of the camera of the present invention is as follows: A camera comprises a lens frame having a reflecting optical member for reflecting light from a subject incoming along a first optical axis toward a second optical axis intersecting the first optical axis, a fixing member having an opening for guiding the subject light to the lens frame along the first optical axis and mounting the lens frame therein, a lens barrier mounted in the fixing member in such a manner to be movable between a position to open the opening and a position to shut the opening, a lens frame mounting part arranged on one side of the lens frame with respect to an optical axis plane defined by the first optical axis and the second optical axis, a drive source arranged in the lens frame to drive a movable lens in the lens frame, and a drive member arranged in the lens frame to drive the lens barrier, wherein the drive member is arranged on the side of the lens frame mounting part with respect to the optical axis plane.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a sectional view of an imaging optical system of a camera on an imaging optical axis plane according to a first embodiment of the present invention;

FIG. 2 is a view as seen from the backside, showing the arrangement inside a lens frame unit housed in a front cover of the camera of FIG. 1;

FIG. 3 is a perspective view as seen from the backside, showing the internal structure of the lens frame unit of FIG. 2;

FIG. 4 is an exploded perspective view showing a mounting state of the lens frame unit into the front cover of the camera of FIG. 1;

FIG. 5 is an exploded perspective view of lens frame mounting parts in the lens frame unit of FIG. 2;

FIG. 6 is a cross-section enlarged view of the lens frame mounting parts of FIG. 5;

FIG. 7 is an exploded perspective view of a lens barrier and a barrier driving transmission part in a camera of FIG. 1;

FIG. 8 is an exploded perspective view of a barrier connection part and the barrier driving transmission part in the camera of FIG. 1;

FIG. 9 is an enlarged sectional view of the barrier driving transmission part of FIG. 8;

FIG. 10 is a schematic plan view showing the arrangement of the barrier connection part and the barrier driving transmission part of FIG. 8;

FIG. 11 is a development view of a cam portion of the barrier connection part of FIG. 8;

FIG. 12 is a view as seen from arrow A in FIG. 10, showing lens barrier open/close states; and

FIG. 13 is a view as seen from the backside, showing the arrangement inside a lens frame unit housed in a front cover of a camera according to a second embodiment of the present invention.

### DETAILED DESCRIPTION OF THE PREFERRED EMBODIMENT

Preferred embodiments of the invention are described below with reference to the accompanying drawings.

In the following description, the right-and-left direction of the camera is expressed as an X direction, the up-and-down direction orthogonal to the X direction (a direction parallel to an optical axis O2 orthogonal to an optical axis O1 to be described later) is expressed as a Y direction, and the front-and-rear direction orthogonal to the X and Y directions is expressed as a Z direction. The Z direction is a direction parallel to the optical axis O1 (that is, the thickness direction of the camera). Further, the subject side of the camera in the Z direction is expressed as a front side, while the photographer side is expressed as a rear side (or backside). The right and left in the X direction are defined when viewed from the backside of the camera. Further, a plane containing both the optical axis O1 and the optical axis O2 in common is expressed as an optical axis plane. The optical axis plane is a plane parallel to a YZ plane.

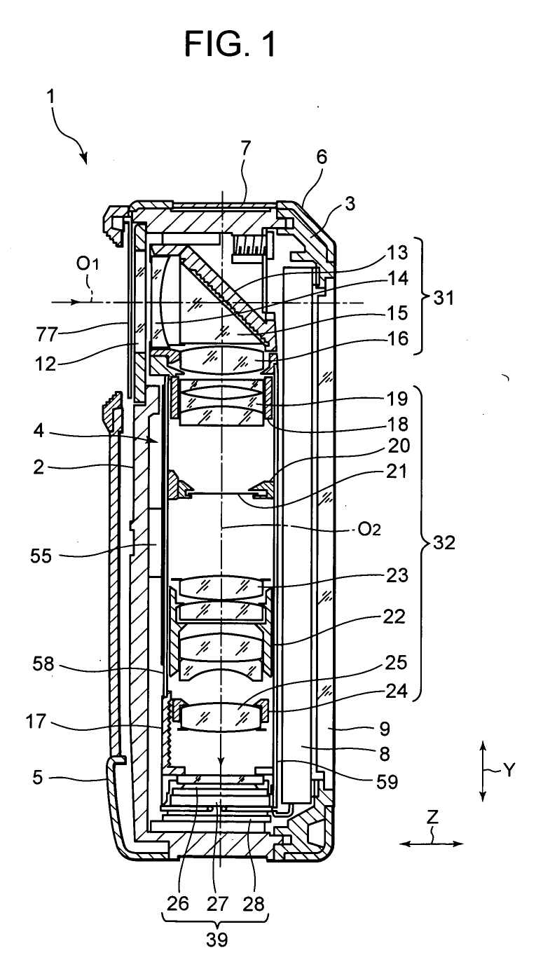

As shown in FIG. 1, a camera 1 of a first embodiment has an exterior package body composed of metal covers 5 and 6 covering the front and rear sides. The camera 1 has a front cover 2 as fixing members for fixing a lens frame unit 4, and a rear cover 3. The lens frame unit 4 as a lens frame is housed on the left side of the covers 2 and 3, while an electric component part (not shown) is housed on the right side of the covers 2 and 3.

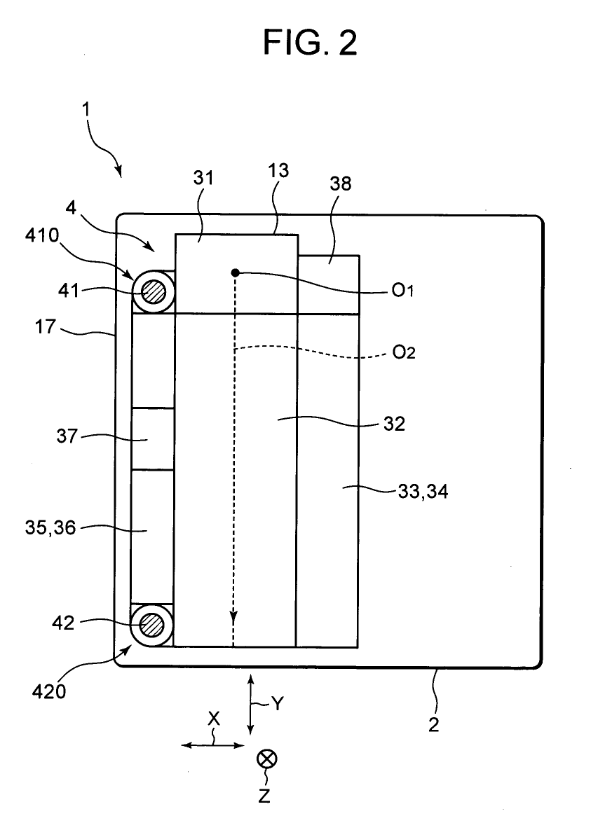

As shown in FIG. 2, the lens frame unit 4 has a lens frame body 17. A reflecting optical system unit 31 arranged in a frame 13 for a reflecting optical system (FIG. 1) is mounted in a center top portion of the lens frame body 17, and an imaging optical system unit 32 is mounted downward of the frame 13 in the center of the lens frame body 17. Further, the lens frame unit 4 has a shutter actuator 37 arranged in a middle left portion of the lens frame body 17, a focus actuator 35/focus unit 36 arranged in a lower left portion of the lens frame body 17, a barrier connection part 38 as a barrier driving member arranged in an upper right portion of the lens frame body 17, and a zoom actuator 33/zoom unit 34 arranged in a lower right portion of the lens frame body 17. Note that the front and rear opening portions of the lens frame body 17 are covered with metal plates 58 and 59 (FIG. 1).

The lens frame unit 4 is supported through the lens frame body 17 by lens frame mounting parts 410 and 420 arranged at two points on the left side of the optical axis plane inside the front cover 2. The lens frame mounting parts 410 and 420 are located at the two points, one being above the shutter actuator 37 and the other being below the focus actuator 35/focus unit 36, to support the lens frame unit 4 in such a manner that the lens frame unit 4 can minutely displace in the Z direction in order to absorb impact forces. Thus, the lens frame mounting parts 410 and 420 are arranged on one side of the lens frame unit 4 with respect to the optical axis plane while being separated from each other in the direction of the optical axis O2.

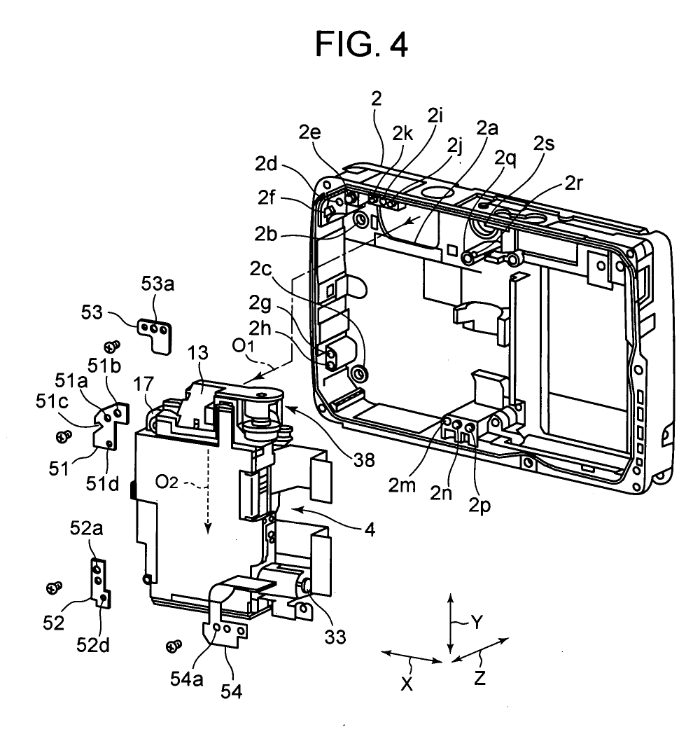

The reflecting optical system unit 31 is assembled in the frame 13 for the reflecting optical system and arranged behind a shooting window part 12 provided as an opening 2a (FIG. 4) in an upper portion of the front cover to face the shooting window part 12. Then, as shown in FIG. 1, the reflecting optical system unit 31 has a first group front lens 14, a prism 15, and a first group rear lens 16. The first group front lens 14 lets subject light in, having the optical axis O1 as a first optical axis. The prism 15 reflects the subject light from the first group front lens 14 toward the direction of the optical axis O2 along the Y direction orthogonal to the optical axis O1. The first group rear lens 16 sends the reflected light from the prism 15 on the side of a second group lens 19 of the imaging optical system unit 32.

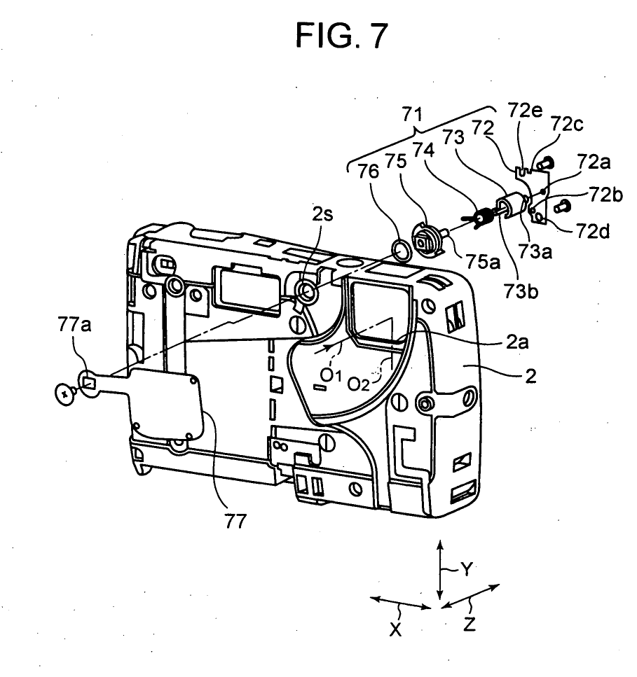

As shown in FIG. 7, a rotatable lens barrier 77 for opening and closing the shooting window part 12 of the front cover 2 is arranged in a forward position of the first group front lens 14. Further, a barrier driving transmission unit 71 for driving the opening and closing of the lens barrier 77 is arranged forward of a barrier connecting part 38 arranged on the right side of the reflecting optical system unit 31.

As shown in FIG. 1, the imaging optical system unit 32 is an optical system having the optical axis O2 as a second optical axis extended downwardly in the center of the lens frame body 17, including the second group lens 19, shutter blades 21, a third group lens 23, a fourth group lens 25, and an imaging unit 39 provided along the optical axis O2 in order. The second lens group is held in a second group frame 18 capable of advancing or retracting. A shutter frame 20 is securely placed not to move. The third lens group 23 is held in a third group frame 22 capable of advancing or retracting. The fourth lens group 25 is held in a fourth group frame 24 capable of advancing or retracting. The imaging unit 39 is securely supported not to move in a bottom portion of the lens frame body 17. The imaging unit 39 includes an optical filter 26, a CCD 27 as an image pickup device, and a CCD support plate 28.

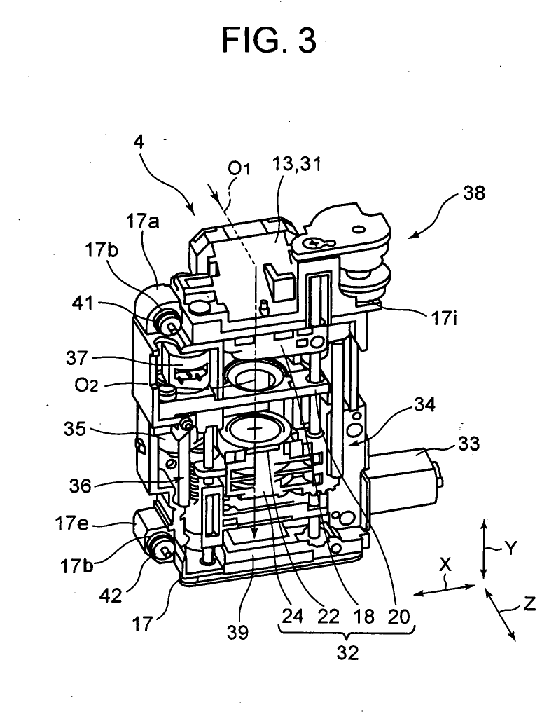

As shown in FIG. 3, the shutter actuator 37 is arranged on the left side of the shutter frame 20 to drive the opening and closing of the shutter blades 21.

The focus actuator 35, arranged under the shutter actuator 37, is an actuator for driving the fourth group frame 24 holding the fourth group lens 25 through the focus unit 36 to advance or retract to perform focusing.

The focus unit 36 is a mechanical part to drive the fourth group frame 24 to advance or retract to perform focusing, and consists of a guide shaft, a threaded lead shaft, etc. arranged along the Y direction in the vicinity of the focus actuator 35.

The zoom actuator 33, arranged in a right end portion of the lens frame body 17 in such a manner to project from the lens frame body 17, is an actuator for driving the second and third frames 18 and 22 through the zoom unit 34 to advance or retract to perform zooming and further driving the barrier connecting part 38 to rotate.

The zoom unit 34 is a mechanical part to drive the second and third frames 18 and 22 to perform zooming, and consists of a guide shaft, a rotation drive shaft, a zoom cam, etc. arranged along the Y direction in the vicinity of the zoom actuator 33.

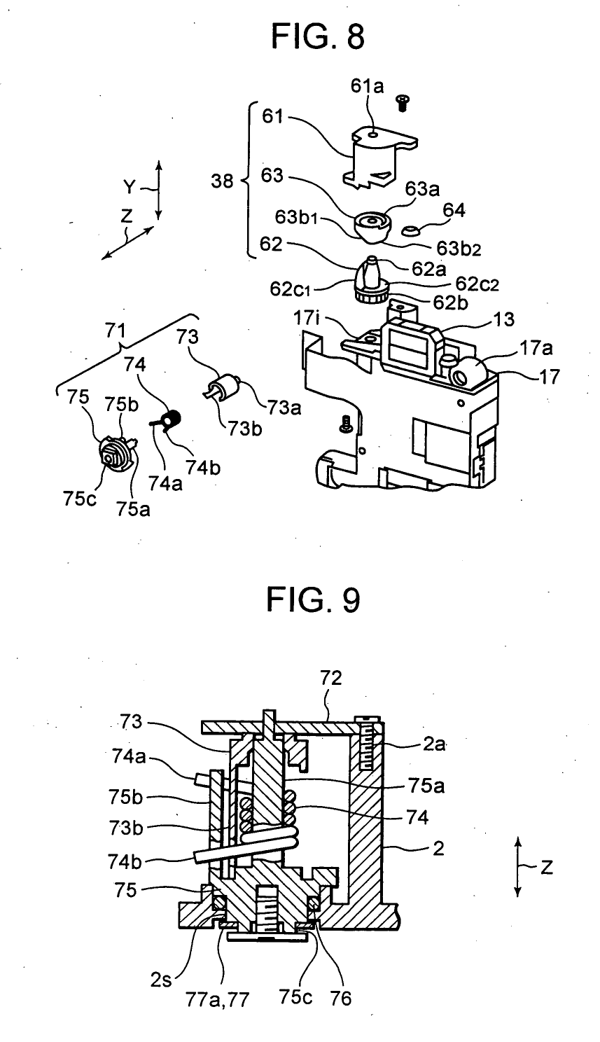

As shown in FIG. 8, the barrier connecting part 38 has a cam section for driving the driving transmission unit 71 to open and close the lens barrier, and is arranged in an upper right portion of the lens frame body 17. The barrier connecting part 38 is driven through a gear by the rotation drive shaft of the zoom unit 34. The details of the barrier connecting part 38 and the driving transmission unit 71 will be described later.

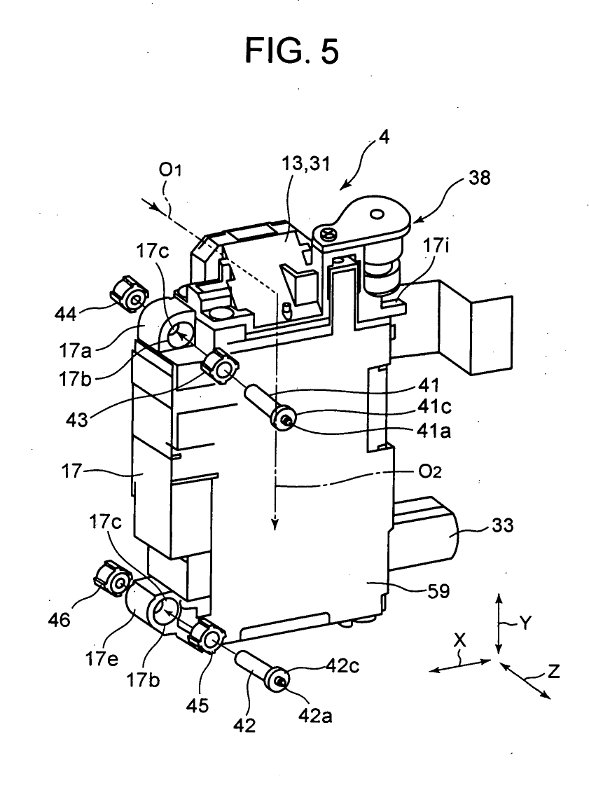

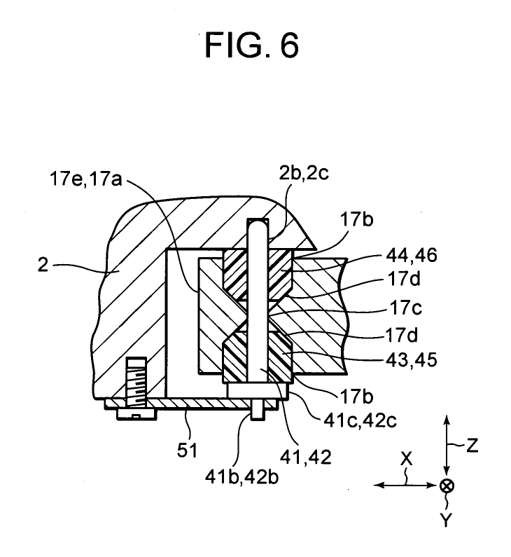

As shown in FIGS. 5 and 6, the lens frame mounting parts include fixed pins 41 and 42 inserted into holes of upper and lower mounting/supporting portions 17a and 17e on the left side of the lens frame body 17, and rubber bushes 43, 44 and 45, 46 as two upper and lower pairs of elastic members. The lens frame mounting parts are arranged at the upper and lower positions of the lens frame body 17 and have substantially the same shape as each other.

In each of the mounting/supporting portions 17a and 17e of the lens frame body 17, a hole section is formed in the Z direction. The hole section is made up of a fitting hole 17c into which each of the fixed pins 41 and 42 fits tightly without leaving any gap therebetween, rubber insert holes 17b provided at both the front and rear of the hole section in a shaft direction (Z direction), a tapered portions 17d provided between the rubber insert holes 17b and the fitting hole 17c, respectively. The fitting hole 17c is formed to be extended from the inner periphery of the hole section so that the width of the fitting hole portion will be reduced through the tapered portion 17d in the shaft direction. Note that the portion of the fitting hole 17c to come in contact with each of the fixed pins 41 and 42 can be formed into a shape having a microarc-like cross section so that each of the fixed pins 41 and 42 will be fitted in linear contact with the fitting portion of the fitting hole 17c.

Each of the rubber bushes 43 and 44 has an outside diameter portion to be deformed and inserted (press-fitted) into the rubber insert hole 17b and an inclined portion that comes into contact with the tapered portion 17d.

One end of each of the fixed pins 41 and 42 is formed into a spheroidal or chamfered edge, with a flange 41c or 42c and a pin portion 41a or 42a formed at the other end.

In the front cover 2, as shown in FIG. 4, shaft insert holes 2b and 2c are provided respectively at upper and lower positions to face the fitting holes 17c in each hole section of the mounting/supporting portions 17a and 17e of the lens frame body 17.

When the lens frame unit 4 is mounted in the front cover 2 through the lens frame mounting parts, the rubber bushes 43, 44 and 45, 46 are mounted into the rubber insert holes 17b of the lens frame body 17, for example, as shown in FIG. 5. After that, the fixed pins 41 and 42 are inserted from their tip side into the rubber bushes 43 and 45, and then into the rubber bushes 44 and 46 through the fitting holes 17c of the lens frame body 17, respectively, in such a manner to allow them to run through the hole sections, respectively. As shown in FIG. 6, the rubber bushes are projecting by a predetermined amount from the front and rear sides of the mounting/supporting portions 17a and 17e, respectively. Under this condition, the fixed pins 41 and 42 are press-fitted in the rubber bushes 43, 45 and 44, 46, and the rear end faces of the rubber bushes 43 and 45 are brought into contact with the flanges 41c and 42c of the fixed pins 41 and 42, respectively.

The lens frame unit 4 in which the fixed pins 41 and 42 and the rubber bushes are mounted is then set into a lens frame mounting portion of the front cover 2 as shown in FIG. 4, inserting the tip portions of the fixed pins 41 and 42 into shaft insert holes 2b and 2c of the front cover 2, respectively, without leaving play therebetween.

After mounting of the fixed pins 41 and 42, the fixed pins 41 and 42 are held down by presser plates 51 and 52 made of a metal plate, respectively. Then, presser plates 53 and 54 made of a metal plate, respectively, are attached to the front cover 2 from the backside of the lens frame body 17. To be more specific, the presser plates 51 and 52 are positioned by positioning pins 2e, 2f, and 2h on the front cover 2 side, and under this condition, screws are inserted into insert holes 51a and 52a and tightened into screw holes 2d and 2g on the lens frame body 17 side. At this time, pin holes 51d and 52d of the presser plates 51 and 52 are inserted on the rear end pin portions 41a and 42a of the fixed pins 41 and 42, respectively, to hold down the flanges 41c and 42c forward, pressing the front and rear projecting portions of the rubber bushes 43, 44 and 45, 46 to deform by a predetermined amount. Thus, the rearward movement of the lens frame unit 4 in a position separated from the lens frame mounting parts is restricted by the presser plates 53 and 54. In this condition, the lens frame unit 4 is being urged rearward with respect to the front cover 2 by means of a cushioning material 55 to be described later.

On the other hand, the presser plates 53 and 54 are positioned by positioning pin 2k, 2j and 2n, 2p on the front cover 2 side, and under this condition, screws are inserted into insert holes 53a and 54a and tightened into screw holes 2i and 2m on the front cover 2 to fix the presser plates 53 and 54, respectively.

In the above-mentioned mounted condition, the mounting/supporting portions 17a and 17e of the lens frame body 17 are sandwiched between the front cover 2 on the front side and the flanges 41c and 42c pressed by the presser plates 51 and 52 on the rear side in the Z direction through the interposition of the front and rear projecting portions of the rubber bushes 43, 44 and 45, 46.

The presser plates 53 and 54 are held on the backside of the lens frame body 17. Therefore, when an impact is applied to the lens frame body 17 to make the lens frame body 17 displace or tilt relative to the impact force, the displacement is restricted by the presser plates 53 and 54. On the other hand, the front side of the lens frame body 17 is kept separated a predetermined distance from the front cover 2 except the portions of the rubber bushes 44 and 46, and the low cushioning material 55 (FIG. 1) is inserted in a compressed state in a position separated from the lens frame mounting parts, such as in a center front portion of the lens frame body 17. Therefore, when the lens frame body 17 relatively displaces or tilts forward in the Z direction, the cushioning material 55 is further compressed to keep the lens frame body 17 from coming in contact with the front cover 2.

When an impact force having a Z directional component is exerted on the camera 1 to which the above-mentioned lens frame mounting parts are applied, the lens frame body 17 displaces with respect to the front cover 2 by a minute amount due to elastic deformation of the rubber bushes 43, 44 and 45, 46, thereby absorbing the impact force. As for components in the X direction (specifically, the direction orthogonal to the optical axis plane containing the optical axis O1 and the optical axis O2) or in the Y direction (specifically, the direction parallel to the optical axis O2), since the lens frame body 17 is supported and restricted not to move by the fixed pins 41 and 42, the position of the lens frame unit 4 on the XY plane is held. In addition, as for rotation components around the X or Y axis and the Z axis, and further around axes tilted with respect to the respective axes, the thickness of the rubber bushes 43, 44 and 45, 46 in the radial direction vary respectively, thereby absorbing the impact force due to the rotation. As mentioned above, since the fitting length of the fixed pins 41, 42 and the respective fitting hole portions 17c is set short, the movement of the lens frame unit 4 in the rotation direction is also allowed, so that impact resistance can be increased.

If a slight clearance is formed between the fixed pins 41, 42 and the respective fitting hole portions 17c, the movement of the lens frame unit 4 in the X and Y directions is also allowed, so that impact resistance can further be increased.

As shown in FIG. 2, in the arrangement of the camera 1 of the embodiment, heavy members, namely the shutter actuator 37, the focus actuator 35, and the focus unit 36 are arranged in upper and lower positions on the left side of the lens frame body 17 of the lens frame unit 4. Further, the lens frame mounting parts are arranged in positions where the heavy members are arranged, so that impact forces exerted on the lens frame unit 4 can be absorbed effectively.

The following describes the barrier connecting part 38 and the barrier driving transmission unit 71 for driving the opening and closing of the lens barrier 77 with reference to FIGS. 7 to 12. The barrier connecting part 38 is driven through a gear by the rotation drive shaft of the zoom unit 34 to drive the driving transmission unit 71 to open or close the lens barrier 77.

As shown in FIG. 8, the barrier connecting part 38 has a lower cam 62, an upper cam 63, and a cam support member 61, and is mounted on an upper right face 17i of the lens frame body 17.

The lower cam 62 has a lower cam portion consisting of an inclined cam surface 62c1 and a flat cam surface 62c2, including a shaft end portion 62a on the top, and a gear portion 62b on the bottom.

The upper cam 63 has an upper cam portion consisting of an inclined cam surface 63b1 and a flat cam surface 63b2.

The lower cam 62 and the upper cam 63 are combined, and an E type retaining ring 64 is fitted onto the shaft end portion 62a to integrate them as a unit, thus forming a cam groove (cylindrical cam) consisting of an inclined cam groove and a flat cam groove. Then, the integrated unit of the lower cam 62 and the upper cam 63 is mounted on the right upper face (on the left upper face in FIG. 8) 17i of the lens frame body 17, and the cam support member 61 is screwed up in such a condition that the shaft end portion 62a is inserted in a shaft hole 61a of the cam support member 61. In this condition, the lower cam 62 and the upper cam 63 can rotate in an integrated manner. The gear portion 62b of the lower cam 62 is meshed with an end gear (not shown) of the zoom unit 34 on the rotation driving shaft side, and driven to rotate by the zoom actuator 33 according to the zooming operation of the camera.

As shown in FIGS. 7 and 8, the barrier driving transmission unit 71 has a driving side transmission member 73, a torsion spring 74, a driven side transmission member 75, and an O ring 76, and is mounted on the upper inner face of the front cover 2 by means of a mounting plate 72.

The driving side transmission member 73 has a cam follower portion 73a projecting from its outer circumference and an engaging protrusion portion 73b projecting forward.

The driven side transmission member 75 has a shaft portion 75a extending rearward, an engaging protrusion portion 75b projecting rearward, and a noncircular barrier engaging portion 75c provided at its front tip.

The driving side transmission member 73 and the driven side transmission member 75 are fitted in the shaft portion 75a so that they can rotate relative to each other. Further, as shown in FIG. 9, the torsion spring 74 is inserted onto the shaft portion 75a, and both of hook portions 74a and 74b of the torsion spring 74 are suspended on the engaging protrusion portion 73b and 75b, respectively, so that the engaging protrusion portions 73b and 75b are hooked in by a predetermined charge force. Therefore, when a driving force smaller than the power of the torsion spring 74 is applied, the driving side transmission member 73 and the driven side transmission member 75 rotate integrally. On the other hand, when a driving force larger than the power of the torsion spring 74 is applied, the driving side transmission member 73 and the driven side transmission member 75 rotate relative to each other while charging the torsion spring 74.

Under the above-mentioned combined condition, the rear end of the shaft portion 75a of the driven side transmission member 75 is inserted into a shaft hole 72a of the mounting plate 72, and the O ring 76 is inserted on the front end side and inserted into a shaft hole 2s of the front cover 2. Then, the mounting plate 72 is positioned by inserting a positioning hole 72b and a notch 72c onto a pin 2r and a positioning pin (not shown) of the front cover 2, respectively. Under this condition, screws are inserted into an insert hole 72d and an insert notch 72e, and tightened into a screw hole 2q and a screw hole (not shown, respectively, to fix the mounting plate 72 (FIG. 4).

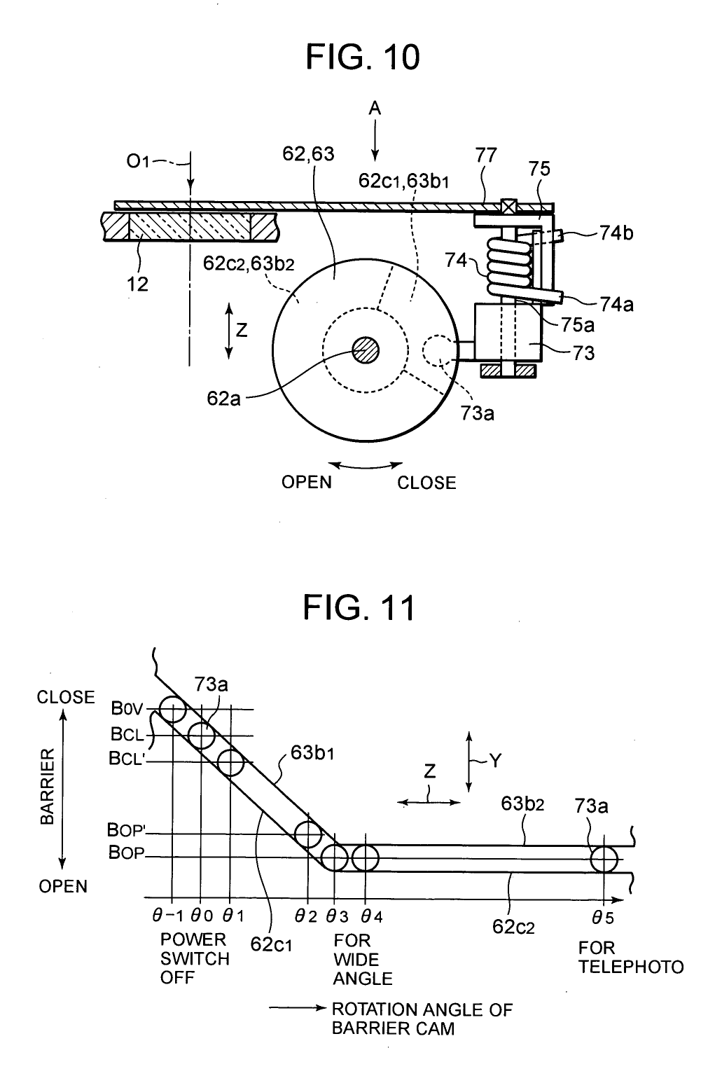

Then, as shown in FIG. 10, the cam follower portion 73a of the driving side transmission member 73 is inserted in and engaged with the cam groove of the upper and lower cams 62 and 63. Thus, the barrier driving transmission unit 71 is engaged with the barrier connecting part 38.

The barrier engaging portion 75c of the driven side transmission member 75 is inserted into a hole portion 77a of the lens barrier 77 to integrate the driven side transmission member 75 and the lens barrier 77 as an unit, so that the lens barrier 77 can be driven to rotate through the driven side transmission member 75.

Note that the shaft hole 2s of the front cover 2 is sealed by the O ring 76 mounted on the driven side transmission member 75 to make it watertight, that is, be resistant to moisture from the outside of the front cover 2. Further, when a force greater than a predetermined value is exerted on the driving side transmission member 73 in either of the directions from the lens barrier 77 side, or when a further rotation driving force is exerted on the driving side transmission member 73 in such a condition that the lens barrier 77 is in contact with a stopper, the torsion spring 74 is overcharged to rotate the driven side transmission member 75 and the driving side transmission member 73 relative to each other by an overcharged amount.

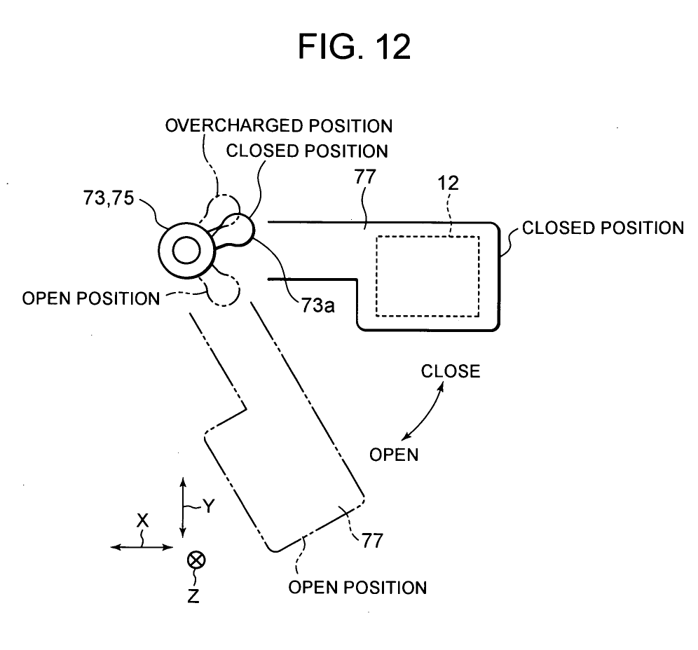

FIG. 11 shows the relationship between the rotation angles of the upper and lower cams 63 and 62 of the barrier connecting part 38 and the state of the lens barrier 77 in such a condition that the barrier connecting part 38 and the barrier driving transmission unit 71 are assembled in the above-mentioned lens frame body 17. When the upper and lower cams 63 and 62 of the barrier connecting part 38 are driven to rotate from rotation angle θ0 at which the camera is power-off state to telephoto rotation angle θ5 via wide-angle rotation angle θ4, the cam follower portion 73a moves from a barrier closed position BCL to a barrier open position BOP along the cam groove of the upper and lower cams 62 and 63. As a result, the lens barrier 77 is driven from a closed position to an open position as shown in FIG. 12.

To be more specific, when the camera becomes power-on state, the upper and lower cams 63 and 62 rotate to θ3 via the rotation angles θ1 and θ2 to open the lens barrier. Therefore, the cam follower portion 73a moves from the barrier closed position BCL on the inclined cam surfaces 62c1 and 63b1 to reach the barrier open position BOP on the flat cam surfaces 62c2 and 63b2 via a barrier quasi-closed position BCL′ and a barrier quasi-open position BOP′. As a result, the lens barrier 77 reaches the open position completely out of the shooting window 12 as shown in FIG. 12.

The barrier quasi-closed position is located slightly close to the barrier open position shown in FIG. 12 but in a position where the lens barrier 77 is still closing the shooting window 12. On the other hand, the barrier quasi-open position is located slightly close to the barrier closed position shown in FIG. 12 but in a position where the lens barrier 77 is not covering the shooting window 12.

After that, when the upper and lower cams 63 and 62 further rotate from the rotation angle θ4 corresponding to a zoom wide-angle end (wide-angle photographable limit) to the rotation angle θ5 corresponding to a zoom telephoto end, the cam follower portion 73a continues to move on the flat cam surfaces 62c1 and 63b2, while the lens barrier 77 remains at the open position.

The following describes the states of the camera 1 when an impact force is exerted on the camera 1 in the Z direction in each of the barrier open and closed conditions. First, if an impact force is exerted in the Z direction in the power-off state, the lens frame body 17 moves slightly in the Z direction. Along with the movement, the upper and lower cams 63 and 62 move in the Z direction (back and forth) relative to the cam follower portion 73a of the driving side transmission member 73. When they move forward, if the moving amount corresponds, for example, to rotation angle θ-1 shown in FIG. 11, the cam follower portion 73a moves to position BOV to overcharge the torsion spring 74. In this condition, the lens barrier 77 is kept stopped at the closed position. On the other hand, when they move rearward, if the moving amount corresponds, for example, to rotation angle θ1 shown in FIG. 11, the cam follower portion 73a moves to the barrier quasi-closed position BCL′ to move the lens barrier 77 to the barrier quasi-closed position.

Thus, even if the lens frame unit 4 displaces by the application of impact or the like in the barrier closed condition, the lens barrier 77 remains covering the shooting window 12. This prevents trouble such as damage to the shooting window 12.

When the upper and lower cams 63 and 62 are at a position of rotation angle θ1, θ2, or θ3, even if the impact is exerted on the camera 1, the lens barrier 77 just moves to a corresponding position according to the relative movement of the upper and lower cams 63, 62 and the driving side transmission member 73. When the upper and lower cams 63 and 62 are at a position of rotation angle θ1, θ2, or θ3, it means that the lens barrier 77 is moving to open or close the shooting window 12. Therefore, there is no functional problem if a slight variation in movement occurs while the lens barrier 77 is moving.

Further, when the upper and lower cams 63 and 62 are at a position from the rotation angle θ4 to θ5, even if the impact is exerted on the camera 1, the cam follower portion 73a just moves on the flat cam portion of the upper and lower cams 63 and 62 without the movement of the lens barrier 77. When the upper and lower cams 63 and 62 are at a position from the rotation angle θ4 to θ5, it means that the camera is ready to shoot. Therefore, if the lens barrier 77 covers the shooting window 12 in this condition, it can interfere with shooting. In contrast, since the embodiment keeps the lens barrier 77 opening the shooting window 12, such a problem never arises.

As discussed above, when the camera 1 receives an impact force in the Z direction so that the lens frame unit 4 will move in the Z direction to absorb the impact, even if the relative position of the barrier connecting part 38 and the barrier driving transmission unit 71 slightly shifts, each of the mechanical parts is not involved in any problem as mentioned above, thereby causing no problem in opening or closing the lens barrier.

According to the camera 1 of the embodiment, the lens frame mounting parts are arranged in upper and lower positions on the left side of the camera, where the heavy components, such as the shutter actuator 37 and the focus actuator 35/focus unit 36 resides, by means of the lens frame unit 4. The lens frame unit 4 is supported movably in the Z direction through the rubber bushes. Therefore, the impact exerted on the camera 1 can be absorbed efficiently. Further, an inertia moment around an axis connecting the upper and lower lens frame mounting parts caused in the camera 1 by the impact force component in the Z direction is relatively small, and this can reduce the influence of the impact on the lens frame unit 4.

Further, when the position of the lens frame unit 4 shifts in the Z direction, although the relative position of the barrier connecting part 38 and the barrier driving transmission unit 71 also slightly shifts, the overcharge of the torsion spring 74 or the cam shape of the barrier connecting part 38 prevents the connecting mechanism or the driving transmission part from bad effects, and hence no trouble occurs in the movement of the lens barrier 77.

The lens frame mounting parts restrict the movement of the lens frame unit 4 in the X direction orthogonal to the optical axis plane. Therefore, the electric components arranged on the right side of the lens frame unit 4 of the front cover 2 can be housed very close to the lens frame unit 4, and this is effective in reducing the size of the camera.

Further, since the lens frame mounting parts are arranged on one side of the lens frame unit with respect to the optical axis plane, the freedom of movement to absorb the impact applied to the lens frame unit 4 can be increased, thereby improving impact resistance. In addition, the number of lens frame mounting parts can be reduced to two, and hence the unit can be made smaller.

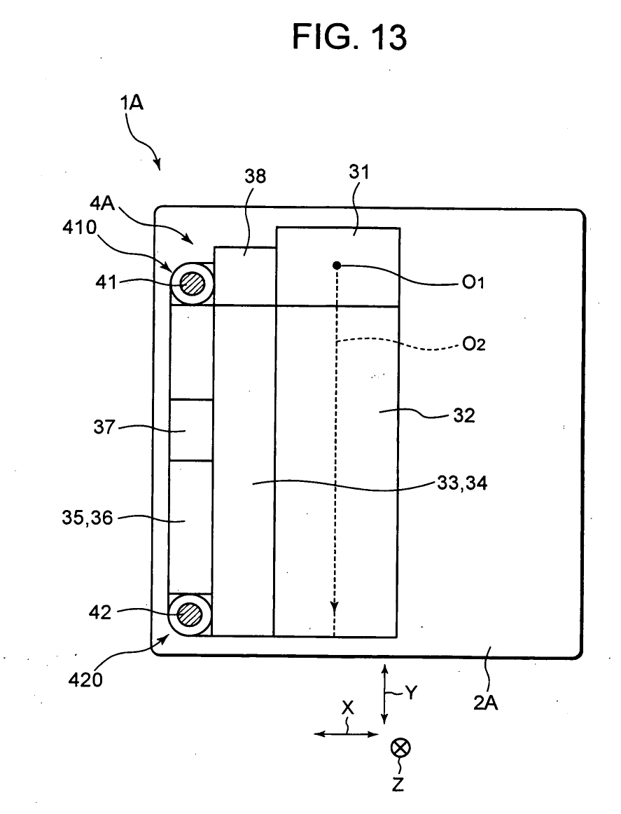

Referring next to FIG. 13, a camera according to a second embodiment of the present invention will be described.

FIG. 13 is a view as seen from the backside, showing the arrangement inside a lens frame unit housed in a front cover of the camera according to the embodiment.

A camera 1A of the embodiment is different from the camera of the first embodiment in the arrangement of component units housed inside the lens frame unit. Since the structure of the embodiment other than the arrangement is the same as that of the camera of the first embodiment, the following describes only the different point.

In the embodiment, a lens frame unit 4A is also mounted in the inner surface of the front cover 2 at upper and lower positions on the left side of the optical axis plane through the lens frame mounting parts arranged at two upper and lower points. Then, the shutter actuator 37 and the focus actuator 35/focus unit 36 are arranged in a lens frame unit 4A at upper and lower positions on the left side of the optical axis plane. The lens frame mounting parts position the lens frame unit 4A in the X and Y directions and support it to be minutely displaceable only in the Z direction in order to absorb impact forces.

Then, as shown in FIG. 13, the embodiment is such that relatively heavy components, namely the barrier connecting part 38 and the zoom actuator 33/zoom unit 34, are arranged in the vicinity of the right side of the lens frame mounting parts, while relatively light components, namely the reflecting optical system unit 31 and the imaging optical system unit 32, are arranged in right outside positions of the barrier connecting part 38 and the zoom actuator 33/zoom unit 34.

In the embodiment, it is assumed that the structure of the lens frame mounting parts is the same as that of the first embodiment.

In the camera 1A of the embodiment, since the heavy barrier connecting part 38 and zoom actuator 33/zoom unit 34 are arranged in the vicinity of the lens frame mounting parts, the inertia moment around the axis connecting the upper and lower lens frame mounting parts caused in the camera 1A by the application of an impact force in the Z direction is made smaller, and this can reduce the influence of the impact on the lens frame unit 4A.

Based on each of the aforementioned embodiments of the present invention, the following structures can be proposed:

(1) A camera comprising:

a lens frame having a reflecting optical member for reflecting light from a subject incoming along a first optical axis toward a second optical axis intersecting the first optical axis;

a fixing member having an opening for guiding the subject light to the lens frame along the first optical axis and mounting the lens frame therein;

a lens barrier mounted in the fixing member in such a manner to be movable between a position to open the opening and a position to shut the opening;

a lens frame mounting part arranged on one side of the lens frame with respect to an optical axis plane defined by the first optical axis and the second optical axis;

a drive source arranged in the lens frame to drive a movable lens in the lens frame; and

a drive member arranged in the lens frame to drive the lens barrier,

wherein the lens frame is mounted in the fixing member through an elastic member arranged in the lens frame mounting part so that the lens frame will be restricted not to move in both a direction orthogonal to the optical axis plane with respect to the fixing member and a direction parallel to the second optical axis while being allowed to move in a direction parallel to the first optical axis in such a condition that the lens frame is mounted in the fixing member through the lens frame mounting part.

(2) The camera according to (1) wherein the drive member has a cam for driving the lens barrier, and the cam has a flat cam portion to make the lens barrier not to displace even if the lens frame moves with respect to the fixing member in the direction parallel to the first optical axis.

This invention is not limited to each of the aforementioned embodiments, and various modifications can be possible without departing from the scope of the invention in its practical phase. Further, each of the aforementioned embodiments includes various aspects of inventions, so that various inventions can be extracted from appropriate combinations of a plurality of elements disclosed in the appended claims.

The camera of the present invention can be used not only as a camera capable of holding a small lens frame having high impact resistance, but also as a camera which makes it easy to mechanically connect the lens frame with other mechanisms.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A camera comprising:
a lens frame having a reflecting optical member for reflecting light from a subject incoming along a first optical axis toward a second optical axis intersecting the first optical axis;
a fixing member mounting the lens frame therein;
a lens frame mounting part arranged on one side of the lens frame with respect to an optical axis plane defined by the first optical axis and the second optical axis; and
a plurality of drive sources arranged in the lens frame to drive movable portions in the lens frame,
wherein at least one of the plurality of drive sources is arranged on the side of the lens frame mounting part with respect to the optical axis plane.

2. The camera according to claim 1 wherein the lens frame is allowed to move in a direction parallel to the first optical axis in such a condition that the lens frame is mounted in the fixing member through the lens frame mounting part.

3. The camera according to claim 1 wherein the lens frame is restricted not to move in both a direction orthogonal to the optical axis plane with respect to the fixing member and a direction parallel to the second optical axis while being allowed to move in a direction parallel to the first optical axis in such a condition that the lens frame is mounted in the fixing member through the lens frame mounting part.

4. The camera according to claim 3 further comprising an elastic member arranged in the lens frame mounting part,
wherein the elastic member elastically deforms to allow the lens frame to move in the direction parallel to the first optical axis.

5. The camera according to claim 1 wherein the lens frame mounting part is provided two in number at two points separated from each other in the direction of the second optical axis.

6. The camera according to claim 5 wherein at least one of the plurality of drive sources is arranged between the lens frame mounting parts provided at the two separated points.

7. The camera according to claim 1 wherein the lens frame mounting part comprises
a mounting/supporting portion provided in the lens frame and having a shaft hole;
a fixed pin inserted through the shaft hole of the mounting/supporting portion;
a fitting portion provided in the fixing member so that the fixed pin will be fitted therein; and
an elastic member arranged between the mounting/supporting portion and the fixed pin.

8. The camera according to claim 7 wherein the shaft hole in the mounting/supporting portion has an elastic member insert portion into which the elastic member is inserted and a fitting portion into which the fixed pin is fitted.

9. The camera according to claim 8 wherein the fixed pin and the fitting portion is fitted in linear contact with each other.

10. A camera comprising:
a lens frame having a reflecting optical member for reflecting light from a subject incoming along a first optical axis toward a second optical axis intersecting the first optical axis;
a fixing member having an opening for guiding the subject light to the lens frame along the first optical axis and mounting the lens frame therein;
a lens barrier mounted in the fixing member in such a manner to be movable between a position to open the opening and a position to shut the opening;
a lens frame mounting part arranged on one side of the lens frame with respect to an optical axis plane defined by the first optical axis and the second optical axis;
a drive source arranged in the lens frame to drive a movable lens in the lens frame; and
a drive member arranged in the lens frame to drive the lens barrier,
wherein the drive member is arranged on the side of the lens frame mounting part with respect to the optical axis plane.

11. The camera according to claim 10 wherein the lens frame is allowed to move in a direction parallel to the first optical axis in such a condition that the lens frame is mounted on the fixing member through the lens frame mounting part.

12. The camera according to claim 10 wherein the lens frame is restricted not to move in both a direction orthogonal to the optical axis plane with respect to the fixing member and a direction parallel to the second optical axis while being allowed to move in a direction parallel to the first optical axis in such a condition that the lens frame is mounted on the fixing member through the lens frame mounting part.

13. The camera according to claim 12 further comprising an elastic member arranged in the lens frame mounting part,
wherein the elastic member elastically deforms to allow the lens frame to move in the direction parallel to the first optical axis.

14. The camera according to claim 10 wherein the lens frame mounting part is provided two in number at two points separated from each other in the direction of the second optical axis.

15. The camera according to claim 14 wherein at least one of the plurality of drive sources is arranged between the lens frame mounting parts provided at the two separated points.

16. The camera according to claim 10 wherein the lens frame mounting part comprises
a mounting/supporting portion provided in the lens frame and having a shaft hole;
a fixed pin inserted through the shaft hole of the mounting/supporting portion;
a fitting portion provided in the fixing member so that the fixed pin will be fitted therein; and
an elastic member arranged between the mounting/supporting portion and the fixed pin.

17. The camera according to claim 16 wherein the shaft hole in the mounting/supporting portion has an elastic member insert portion into which the elastic member is inserted and a fitting portion into which the fixed pin is fitted.

18. The camera according to claim 17 wherein the fixed pin and the fitting portion is fitted in linear contact with each other.

19. The camera according to claim 10 wherein the drive member has a cam for driving the lens barrier and the cam has a flat cam portion to make the lens barrier not to displace even if the lens frame moves with respect to the fixing member in the direction parallel to the first optical axis.
